(19) United States
(12) Patent Application Publication
(10) Pub. No.: US 2023/0131152 A1
(43) Pub. Date: Apr. 27, 2023

(54) SAMPLE SEPARATION NETWORK WITH SIMPLY CONNECTABLE SAMPLE SEPARATION DEVICE

(71) Applicant: Agilent Technologies, Inc., Santa Clara, CA (US)

(72) Inventors: Thomas Romanowski, Karlsruhe (DE); Frank Maar, Waldbronn (DE); Bruce James Dolby, Waldbronn (DE); Stefan Huber, Waldbronn (DE)

(73) Assignee: Agilent Technologies, Inc., Santa Clara, CA (US)

(21) Appl. No.: 17/912,464

(22) PCT Filed: Mar. 15, 2021
(86) PCT No.: PCT/IB2021/052125

§ 371 Date: Sep. 16, 2022

(30) Foreign Application Priority Data
Mar. 20, 2020 (GB) 2004054.9

(51) Int. Cl. H04L 41/0806; G01N 35/00; G01N 30/88; B01D 15/24; B01D 15/14

(52) U.S. Cl. CPC H04L 41/0806; G01N 35/00871; G01N 30/88; B01D 15/247; B01D 15/14; G01N 2035/00881; G01N 2030/8804

(57) ABSTRACT

A sample separation network includes a server node, a plurality of client nodes coupled with the server node, a plurality of sample separation devices coupled with the server node, wherein each of the sample separation devices includes device-specific control software configured for controlling specifically the respectively assigned sample separation device, wherein at least one of the server node and the client nodes includes generic control software configured for generically controlling sample separation devices in a non-device-specific way, and wherein at least one of the server node and the client nodes and the sample separation devices is configured for loading device-specific control software from a sample separation device to at least one of the server node and the client nodes upon connection of said sample separation device to the sample separation network.

### BACKGROUND ART

The present invention relates to a sample separation network, a method of operating a sample separation network, a program element and a computer readable medium.

Fluidic devices are applied to execute various measurement tasks in order to measure any kind of physical parameter. Each fluidic device may have a specific driver with device specific commands. A programming software allows a user to design an operation mode of the fluidic device. As a result of such a design, the fluidic device may be operated in accordance with the designed operation mode.

More particularly, in liquid chromatography, a fluidic analyte may be pumped through a column comprising a material which is capable of separating different components of the fluidic analyte. Such a material, so-called beads, may be filled into a column tube which may be connected to other elements (like a control unit, containers including sample and/or buffers). Upstream of a column, the fluidic analyte is loaded into the liquid chromatography apparatus. A controller controls an amount of fluid to be pumped through the liquid chromatography apparatus, including controlling a composition and time-dependency of a solvent interacting with the fluidic analyte. Such a solvent may be a mixture of different constituents.

For instance in companies and research facilities, multiple sample separation devices may be connected to a network. However, connecting a new sample separation device to a sample separation network may be cumbersome, because this conventionally requires a significant adaptation of the existing network.

### DISCLOSURE

It is an object of the invention to simplify connection of an additional sample separation device to an existing sample separation network. The object is solved by the independent claims. Further embodiments are shown by the dependent claims.

According to an exemplary embodiment, a sample separation network is provided, wherein the sample separation network comprises a server node, a plurality of client nodes communicatively coupled with the server node, and a plurality of sample separation devices communicatively coupled with the server node. Each of the sample separation devices may comprise device-specific control software configured for controlling specifically the respectively assigned sample separation device. The server node and/or at least one of the client nodes may comprise generic control software configured for generically controlling sample separation devices in a non-device-specific way. At least one of the server node and the client nodes and the sample separation devices and may be configured for loading device-specific control software from a sample separation device to at least one of the server node and the client nodes upon connection of said sample separation device to the sample separation network.

According to another exemplary embodiment, a method of operating a sample separation network is provided, wherein the method comprises communicatively coupling a plurality of client nodes with a server node, communicatively coupling a plurality of sample separation devices with the server node, providing each of the sample separation devices with device-specific control software configured for controlling specifically the respectively assigned sample separation device, and providing the server node and/or at least one of the client nodes with generic control software configured for generically controlling sample separation devices in a non-device-specific way. Furthermore, the method may comprise loading device-specific control software to said at least one of the server node and the client nodes from a sample separation device upon connection of said sample separation device to the sample separation network.

According to still another exemplary embodiment of the invention, a program element (for instance a software routine, in source code or in executable code) is provided, which, when being executed by one or more processors (such as a microprocessor or a CPU), is adapted to control or carry out a method having the above mentioned features.

According to yet another exemplary embodiment of the invention, a computer-readable medium (for instance a CD, a DVD, a USB stick, a floppy disk or a hard disk) is provided, in which a computer program is stored which, when being executed by one or more processors (such as a microprocessor or a CPU), is adapted to control or carry out a method having the above mentioned features.

Data processing which may be performed according to embodiments of the invention can be realized by a computer program, that is by software, or by using one or more special electronic optimization circuits, that is in hardware, or in hybrid form, that is by means of software components and hardware components.

In the context of the present application, the term “sample separation device” may particularly denote any apparatus which involves the transport, analysis or processing of fluids for separation of a fluidic sample. A fluid may denote a liquid, a gas or a combination of a liquid and a gas, and may optionally also include solid particles, for instance forming a gel or an emulsion. Such a fluid may comprise a fluidic solvent and/or a fluidic sample under analysis. Examples for sample separation devices are chemical analysis devices, life science apparatuses or any other biochemical analysis system such as a separation device for separating different components of a sample, particularly a liquid chromatography device. For example, the sample separation can be done by chromatography or electrophoresis. The sample separation device may have a communication interface enabling the sample separation device to be communicatively coupled within the sample separation network.

In the context of the present application, the term “fluidic sample” may particularly denote a medium containing the matter which is actually analyzed (for example a biological sample, such as a protein solution, a pharmaceutical sample, etc.).

In the context of the present application, the term “mobile phase” may particularly denote a fluid (in particular a liquid) which serves as a carrier medium for transporting a fluidic sample from a fluid drive (such as a high pressure pump) to a sample separation unit (such as a chromatographic column) of a sample separation device. For example, the mobile phase may be a (for example, organic and/or inorganic) solvent or a solvent composition (for example, water and ethanol).

In the context of the present application, the term “node” may particularly denote a communication end point or an electronic device that is attached to the sample separation network and is capable of creating, receiving and/or transmitting information, data and/or messages over a communications channel.

In the context of the present application, the term “server node” may particularly denote a computer program or a device that provides functionality for other programs or devices, namely the client nodes. The network with server node and client nodes may thus be a client-server network. A server node can provide various functionalities or services, such as sharing data or resources among multiple client nodes, or performing computation for a client node. A single server node can serve or control multiple client nodes.

In the context of the present application, the term “client node” may denote a piece of computer hardware or software that accesses a service made available by a server node. For instance, the server node may be a computer system which can be accessible by a client node (which may be another computer system) by way of the sample separation network. The respective client node may operate within the sample separation network together with the server node in accordance with a client-server architecture.

In the context of the present application, the term “device-specific control software” may particularly denote a software which is specifically configured for operating a sample separation device in terms of controlling its sample separation functionality. In other words, such a device-specific control software may be specifically related to the particularities of the assigned sample separation device (for instance assigned to a specific type of sample separation device) in terms of its sample separation capability. Rather than being an unspecific software piece, such a device-specific control software may be only usable for in the context of a sample separation task, not for not sample separation related tasks. In particular, the device-specific control software may include instructions defining how to carry out a sample separation by the assigned sample separation device or type of sample separation device. For instance, the device-specific control software may include instructions how to control a fluid drive unit (for instance a chromatographic high-pressure pump) in terms of the sample separation. The device-specific control software may also include instructions how to create a solvent composition as a mobile phase used for the sample separation (for instance defining a gradient run). Moreover, the device-specific control software may include instructions how to inject a fluidic sample into a mobile phase by correspondingly operating an injector. Beyond this, the device-specific control software may include instructions how to operate a detector (for instance a fluorescence detector) for detecting separated fractions of a fluidic sample separated by the sample separation device.

In the context of the present application, the term “generic control software” may particularly denote a software providing a contribution to a communication or control within a network but being not at all specifically adapted for sample separation purposes or corresponding sample separation device-specific control tasks. In contrast to this, such a generic control software may be completely unspecific concerning the supported task and may not be able to control alone a sample separation device for separating a fluidic sample without being combined with a device-specific control software.

In the context of the present application, the term “connection of a sample separation device to the sample separation network” may particularly denote the process of adding (or communicatively coupling) a sample separation device to the sample separation network which has previously not formed part of the sample separation network, i.e. which has previously not been communicatively coupled with the server node, the client nodes and already connected sample separation devices of the sample separation network. Connecting such a sample separation device to the network may be done by a physical plugging action and/or by a (for instance wireless) communication coupling action. In other words, connecting a sample separation device to a sample separation network may extend the sample separation network to include or encompass in the future additionally also the connected sample separation device.

According to an exemplary embodiment of the invention, a sample separation network architecture is provided which simplifies a reconfiguration effort when extending the sample separation network by adding one or more further previously not connected sample separation devices (or types of sample separation devices) to the network. Providing a server node and/or client nodes with generic control software while installing device-specific control software on the sample separation devices allows to freely connect a further sample separation device to the sample separation network without the need of extensively updating the software configuration in the existing nodes of the sample separation network when extending the network by one or more additional sample separation devices. In conventional approaches, in which device-specific control software has also been part of the server node and/or the client nodes, connecting a further sample separation device to the network required extensive update effort for the already existing nodes of the network. By the described separation of sample separation device-specific control software (installed initially on the sample separation devices only) from merely generic control software installed on server node and/or at least part of the client nodes, neither the server node nor the client nodes require a specific software update or a revalidation when a new sample separation device is added to the separation network. This can be ensured by configuring the network (for instance by configuring at least one of its nodes and/or a sample separation device to be connected) to initiate a download of the device-specific control software from a newly connected sample separation device to at least one of the nodes when establishing the communication connection of said additional sample separation device with the network. Thus, by merely communicatively coupling the sample separation device to the already existing sample separation network in a plug and play fashion, the described distributed software configuration in combination with the download task allows client nodes and/or the server node to control the newly connected sample separation device without previously carrying out software updates on the server node or the client nodes. This significantly increases the flexibility of extending sample separation networks and reduces the effort in terms of software administration.

Next, further exemplary embodiments of the sample separation network, the method of operating a sample separation network, the program element and the computer readable medium will be explained.

In an embodiment, the generic control software is incapable of controlling the sample separation devices in a device-specific manner. In other words, the generic control software may be a general purpose software without specific relation to sample separation purposes carried out on a specific sample separation device or on a specific type of sample separation device and may thus be not able to control a sample separation device of the sample separation network without being supported by sample separation device-specific control software (which may be initially available on a sample separation device only and may be downloaded therefrom).

In an embodiment, the generic control software is incapable of controlling a respective one of the sample separation devices without the assigned device-specific control software. Thus, only the combination of device-specific control software with generic control software may be capable of controlling a sample separation device by a client node or a server node in the framework of a sample separation task, but not the generic control software alone.

In an embodiment, the device-specific control software is configured for controlling each of the sample separation devices. In such a configuration, the device-specific control software may be specific for sample separation purposes, but may be capable of driving different sample separation devices or types of sample separation devices in the sample separation network. For instance, this may make it possible to install the same device-specific control software on each of the sample separation devices of the sample separation network. This keeps the overall requirements in terms of software development for operating the sample separation network low.

In an embodiment, a part of the generic control software is installed on the server node and another part of the generic control software is installed on the client nodes. Hence, the generic control software may be distributed over the client nodes and the server node. For instance, a general part of the generic control software may be stored on the server node. A client specific part of the generic control software may be installed on the client nodes. The cooperation between said parts of the generic control software may then enable in particular the control of a sample separation device by a client via the server node, in combination with device-specific control software. The described software configuration keeps the overall effort in terms of software installation and software administration in the sample separation network low.

In an embodiment, the client nodes are communicatively coupled with the sample separation devices only indirectly via the server node. In such an embodiment, there is no direct communication between the client nodes and the sample separation devices. When a client node desires to control a sample separation process on a sample separation device, the client node communicates with the server node and the server node forwards corresponding control commands with or without changes to the respective sample separation device. Alternatively, it may however be possible that a client node directly controls a sample separation device without the server node in between.

In an embodiment, the server node is configured for controlling a plurality of sample separation devices, in particular simultaneously. Hence, the server node may be configured as a central control node which controls multiple sample separation devices and preferably also multiple client nodes at the same time. This keeps the hardware and software effort of the sample separation network low.

In an embodiment, neither the server node nor the client nodes stores device-specific control software for specifically controlling a specific sample separation device of a certain type before connecting said sample separation device to the network. By keeping sample separation device-specific control software away from server node and client nodes up to a connection-triggered loading task, the connection of a further sample separation device to the sample separation network does not require any software update on the server node and the client nodes. The server node and/or the client nodes may directly start to control the newly connected sample separation device, since the connection of such a new sample separation device may trigger a download of the device-specific control software onto the server node and/or the client nodes.

In an embodiment, the generic control software comprises a driver interface for driving the sample separation devices. A driver software may provide a programming interface to control and manage specific lower level interface that may be linked to a specific type of hardware or other low-level service. In particular, the generic control software may enable a client node or a server node to drive the respective sample separation device after the connection-triggered download of the sample separation device-specific control software from the connected sample separation device to the server node or the client node.

In an embodiment, said at least one of the server node and the client nodes and the sample separation devices is configured for loading said device-specific control software from a new connected sample separation device (in particular of a sample separation device type previously unknown in the sample separation network) triggered merely by said connection of said sample separation device to the sample separation network without an additional user intervention. Hence, the sample separation network may be specifically configured for detecting the event that a sample separation device is newly connected to the sample separation network. If this is detected, the client nodes and/or server node may be provided with this information. The respective node may then start to automatically download the device-specific control software from the newly connected sample separation device without the need that a user contributes or carries out any control task. It may also be possible that, triggered by its connection to the network, the newly connected sample separation device starts to automatically load its device-specific control software to the server node and/or at least one of the client nodes. It may be sufficient that a user only physically plugs or communicatively connects the sample separation device to the sample separation network, and no other user action will be required for enabling the user to control the newly connected sample separation device from one of the client nodes. The event of connecting the sample separation device to the sample separation network may automatically trigger the download of the device-specific control software from the newly connected sample separation device to the server node and/or the client nodes.

In an embodiment, the generic control software is a standard browser. In the context of the present application, the term “browser” may particularly denote a software application for accessing information on the sample separation network, for instance via the WorldWideWeb or public Internet. However, a browser may also enable accessing information via another network type, such as an Intranet or a mobile phone network. When a user requests a particular information via the sample separation network, the browser may retrieve the necessary content from the server node and/or client nodes and/or sample separation devices and may then display a resulting information on the requesting node or device. Examples of usable browsers are the Microsoft Internet Explorer®, Google Chrome®, Safari®, a proprietary browser, etc.

In an embodiment, the method comprises loading said device-specific control software and subsequently operating the connected sample separation device in terms of separating a fluidic sample without previously updating the server node and/or the plurality of client nodes in accordance with the device-specific control software of the sample separation device connected to the sample separation network. Thus, with the described software configuration on the sample separation network (i.e. the distribution of the generic control software and the device-specific control software as described above) enables the connection of a new type of sample separation device to the sample separation network without the need to carry out a new installation or updates on the server node and the client nodes. This simplifies operation of the sample separation network for a user and for a system administrator.

In an embodiment the method comprises controlling the sample separation device after its connection to the sample separation network by at least one of the server node and the client nodes without previously updating neither the server node nor the client nodes after said connecting. Hence, a user may for instance access a sample separation device for controlling a sample separation task from a client node without the need of previously changing the software configuration of its client node or the server node.

In an embodiment, the device-specific control software is configured for controlling the respectively assigned sample separation device to carry out a sample separation process of separating a fluidic sample. During this task, the generic control software may provide a browser function only, while the sample separation related tasks may be carried out under control of the device-specific control software only.

Embodiments of the invention may be implemented in conventionally available HPLC systems, such as the Agilent 1200 (or 1290) Series Rapid Resolution LC system or the Agilent 1150 HPLC series (both provided by the applicant Agilent Technologies—see www.agilent.com—which shall be incorporated herein by reference).

One embodiment of a sample separation device comprises a pump having a pump piston for reciprocation in a pump working chamber to compress liquid in the pump working chamber to a high pressure at which compressibility of the liquid becomes noticeable. This pump may be configured to know (by means of operator's input, notification from another module of the instrument or similar) or elsewise derive solvent properties.

The separation unit of the sample separation device preferably comprises a chromatographic column (see for instance http://en.wikipedia.org/wiki/Column chromatography) providing a stationary phase. The column may be a glass or steel tube (for instance with a diameter from 50 μm to 5 mm and a length of 1 cm to 1 m) or a microfluidic column (as disclosed for instance in EP 1577012 or the Agilent 1200 Series HPLC-Chip/MS System provided by the applicant Agilent Technologies). The individual components are retained by the stationary phase differently and at least partly separate from each other while they are propagating at different speeds through the column with the eluent. At the end of the column they elute one at a time or at least not entirely simultaneously. During the entire chromatography process the eluent may be also collected in a series of fractions. The stationary phase or adsorbent in column chromatography usually is a solid material. The most common stationary phase for column chromatography is silica gel, surface modified silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface.

The mobile phase (or eluent) can be a pure solvent or a mixture of different solvents (such as water and an organic solvent such as ACN, acetonitrile). It can be chosen for instance to adjust the retention of the compounds of interest and/or the amount of mobile phase to run the chromatography. The mobile phase can also be chosen so that the different compounds or fractions of the fluidic sample can be separated effectively. The mobile phase may comprise an organic solvent like for instance methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The fluidic sample may comprise but is not limited to any type of process liquid, natural sample like juice, body fluids like plasma or it may be the result of a reaction like from a fermentation broth.

The pressure, as generated by the fluid drive, in the mobile phase may range from 2-200 MPa (20 to 2000 bar), in particular 10-150 MPa (150 to 1500 bar), and more particular 50-120 MPa (500 to 1200 bar).

The sample separation device, for instance an HPLC system, may further comprise a detector for detecting separated compounds of the fluidic sample, a fractionating unit for outputting separated compounds of the fluidic sample, or any combination thereof. Further details of such an HPLC system are disclosed with respect to the Agilent 1200 Series Rapid Resolution LC system or the Agilent 1150 HPLC series, both provided by the applicant Agilent Technologies, under www.agilent.com which shall be in cooperated herein by reference.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a sample separation network with client-server architecture and with multiple liquid sample separation devices in accordance with embodiments of the present invention.

FIG. 2 shows a liquid sample separation device within the network of FIG. 1, particularly used in high performance liquid chromatography (HPLC).

FIG. 3 shows a hardware and software configuration of a sample separation device communicatively coupled with a server node or a client node according to an exemplary embodiment.

FIG. 4 illustrates a limited software reconfiguration effort when adding a new type of sample separation device to an existing sample separation network according to an exemplary embodiment.

FIG. 5 shows a configuration of a sample separation network according to an exemplary embodiment enabling the connection of a new sample separation device to the network without changes in an existing validated software installation.

FIG. 6 shows a configuration of a server node and a client node enabling a simplified connection of a previously unknown type of sample separation device to a sample separation network according to an exemplary embodiment.

The illustration in the drawing is schematically.

Before describing the figures in further detail, some basic considerations of the present invention will be summarized based on which exemplary embodiments have been developed.

It may happen that users operate multiple sample separation devices with a software which is used overall a sample separation network, for instance of a company, a search facility or another entity. It may be desired that each of multiple sample separation devices (for instance liquid chromatography devices) can be operable from each client node of the sample separation network. However, it is conventionally cumbersome that each client node and each server node needs a software update upon connection of a new type of sample separation device to the sample separation network. Thus, the requirement of updating server node and each client node when connecting a new sample separation instrument to the sample separation network is cumbersome.

In order to overcome the above and/or other shortcomings, a sample separation network according to an exemplary embodiment of the invention initially implements a sample separation device-specific control software on the sample separation devices only. In contrast to this, the server node and/or the client nodes of the sample separation network may be initially provided only with generic, i.e. not sample separation device-specific, control software, such as a simple browser software. When connecting a new type of sample separation device to the sample separation network (for instance an additional liquid chromatography device of a device type which has not previously been connected to the network), the client nodes and the server node can continue to operate within the sample separation network, also in terms of controlling the newly added sample separation device, without the requirement of an update on these nodes. This can be ensured by loading sample separation device-specific control software from the newly added sample separation device to the server node and/or the client nodes only when the connection of the new sample separation device to the sample separation network is detected, identified or communicated to the server node and/or client nodes. In other words, the generic control software and/or a service on the newly added device may load the device-specific control software from the newly added sample separation device to the server node and/or the client nodes upon connecting the sample separation device to the sample separation network.

Thus, an exemplary embodiment of the invention provides a sample separation network with a server node, client nodes and multiple sample separation devices having a device-specific control software. In contrast to this, a generic control software is provided on the client nodes and/or the server. The generic control software implemented on server node and/or client nodes may be configured for downloading the device-specific control software from a newly added sample separation device when the sample separation device is connected to the sample separation network. Advantageously, the generic control software may be partially implemented on the server node and partially on the client nodes. The server node may control multiple clients. There may be no need of any updates on the server node and/or the client nodes when connecting a new sample separation device to the sample separation network, and at the same time a direct control of the newly added sample separation device by the server node or any of the client nodes may be possible. For instance, the generic control software may be a sample separation unspecific software, for instance a mere driver for liquid chromatography devices without specification of a certain type of sample separation nodes (for instance a liquid chromatography separation type).

In a conventional architecture, adding a new sample separation device requires the provision of new drivers. Thus, this requires the client nodes and the server node to be updated. This, however, involves a high update and revalidation effort depending on the compliant policies of a user. New drivers need to be available for a corresponding revision. Furthermore, an extensive revision of the software system is needed if new drivers are incompatible with current user installation.

In contrast to such conventional approaches, a sample separation network according to an exemplary embodiment of the invention allows to add a new sample separation device in a plug and play type, so that the new sample separation device works out of the box. By distributing the required control software to device-specific control software implemented on the sample separation devices and generic control software installed on server node and/or client nodes, no software or driver installation is needed when a new or additional sample separation device (or device type) is connected to the sample separation network. In particular, the instrument (or device) specific functionality may be completely contained in the instrument (or device) itself. As a result, also the revalidation scope is smaller, if there is any at all. In one embodiment, only a newly added sample separation device or instrument needs to be validated, whereas the software installation on the server node and/or the client nodes may remain unchanged. Furthermore, there is no dependency between the revision of the server node and the client nodes on the one hand and the sample separation devices on the other hand.

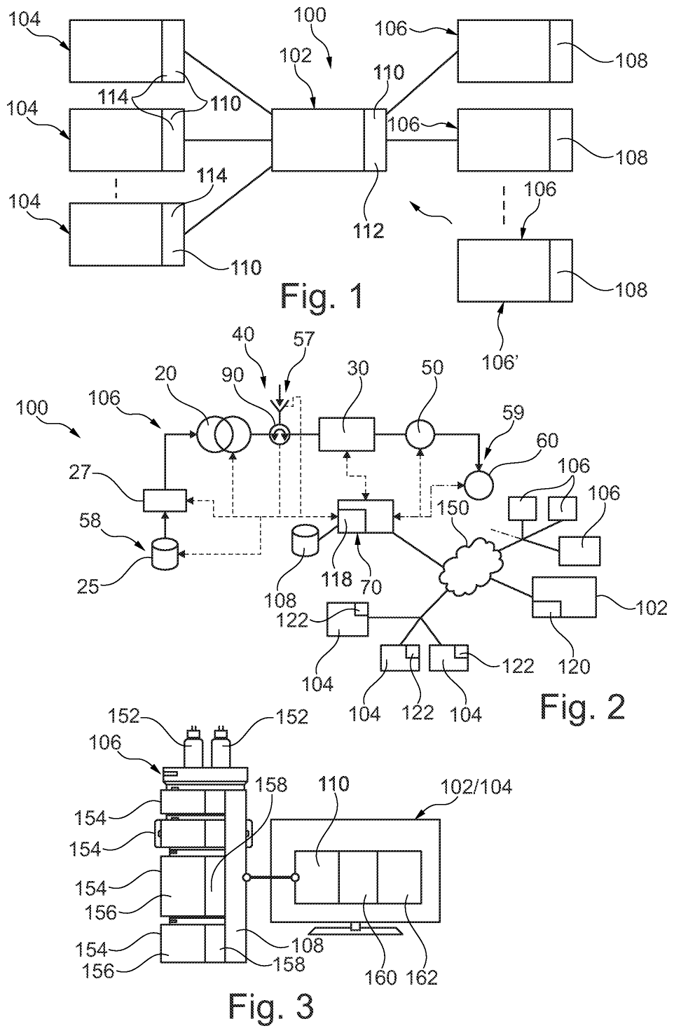

FIG. 1 shows a client-server type sample separation network 100 with multiple liquid sample separation devices 106, embodied as a pool of liquid chromatography devices, in accordance with embodiments of the present invention.

The illustrated sample separation network 100 comprises a computer as server node 102 as an overall controller of communication within sample separation network 100. The server node 102 (which may be denoted as acquisition server) may control multiple sample separation devices 106. In particular, the server node 102 may be configured for controlling a plurality of sample separation devices 106 simultaneously.

Furthermore, the sample separation network 100 comprises a plurality of client nodes 104 each being directly communicatively coupled with the server node 102. Each client node 104 may be a computer.

A plurality of sample separation devices 106 is communicatively coupled with the server node 102. Communication between a respective one of the client nodes 104 and a respective one of the sample separation devices 106 may be carried out indirectly via the server node 102. In other words, the client nodes 104 are communicatively coupled with the sample separation devices 106 only indirectly via the server node 102.

Alternatively, it also be possible that a respective one of the client nodes 104 communicates with a respective one of the sample separation devices 106 directly, i.e. without the server node 102 in between. Although a specific number of client nodes 104 and sample separation devices 106 is shown in FIG. 1, any other number of client nodes 104 and sample separation devices 106 is possible. Furthermore, it may also be possible that the sample separation network 100 comprises multiple server nodes 102.

As indicated in FIG. 1, each of the sample separation devices 106 stores and has installed device-specific control software 108 configured for controlling specifically the respectively assigned sample separation device 106.

Moreover, the server node 102 stores and has installed generic control software 110 which is configured for generically controlling sample separation devices 106 in a non-device-specific way. Also the client nodes 104 store and have installed generic control software 110 which is configured for generically controlling sample separation devices 106 in a non-device-specific way. For instance, a part 112 of the generic control software 110 is installed on the server node 102 and another part 114 of the generic control software 110 is installed on the client nodes 104.

Beyond this, the server node 102 and/or one or more of the client nodes 104 and/or a newly connected sample separation device 106′ is configured for loading device-specific control software 108 from said sample separation device 106′ to at least one of the server node 102 and the client nodes 104 upon connection of said sample separation device 106′ to the sample separation network 100. More specifically, the server node 102 and/or the client nodes 104 and/or the newly connected sample separation device 106′ may be configured for loading said device-specific control software 108 from a sample separation device 106′ triggered merely by said connection of said sample separation device 106′ to the sample separation network 100 without an additional user intervention. The mentioned functionality (i.e. the existence of generic control software 110 and/or the described loading capability) may be provided only by the server node 102 or only by one or more of the client nodes 104 or by both the server node 102 and the client nodes 104. A connected sample separation device 106′ may or may not contribute to the triggering of the loading task.

The generic control software 110 installed on the server node 102 and/or the client nodes 104 is incapable of controlling the sample separation devices 106 in a device-specific manner. In particular, the generic control software 110 is incapable of controlling a respective one of the sample separation devices 106 without the assigned device-specific control software 108. The generic control software 110 may comprise a driver interface for driving the sample separation devices 106. For instance, the generic control software 110 may only provide a browser function.

In contrast to this, the device-specific control software 108 installed on each of the sample separation devices 106 is configured for controlling each of the sample separation devices 106, in particular in terms of sample separation. More specifically, the device-specific control software 108 may function to control the respectively assigned sample separation device 106 to carry out a sample separation process of separating a fluidic sample. Contrary to this, neither the server node 102 nor the client nodes 104 comprises initially (i.e. before the loading) device-specific control software 108 for specifically controlling a specific sample separation device 106.

Advantageously, operation of the sample separation network 100 may encompass loading said device-specific control software 108 without updating the server node 102 and/or the plurality of client nodes 104 in accordance with the device-specific control software 108 of the new type of sample separation device 106′ connected to the sample separation network 100. Moreover, the server node 102 may be enabled to control the sample separation device 106′ after its connection to the communication network 100 without previously updating neither the server node 102, nor the client nodes 104 after said connecting.

Hence, FIG. 1 shows the scenario that a new sample separation device 106′ (which may be constructed as shown in FIG. 2) is added to an existing sample separation network 100 which already comprises connected sample separation devices 106 (which may be embodied as shown in FIG. 2 as well). When the new sample separation device 106′ is added to the sample separation network 100, for instance by communicatively coupling it with server node 102, the presence of a new sample separation device 106′ may be detected, for instance by the server node 102 and/or by the client nodes 104. For instance, such a detection may be based on a communication message which is automatically sent from the sample separation device 106′ upon being connected to sample separation network 100. After having identified the addition or connection of a new sample separation device 106′ to the sample separation network 100, the server node 102 and/or the client nodes 104 may automatically trigger a download from the sample separation device-specific control software 108 from the newly added sample separation device 106′ to the server node 102 and/or the client nodes 104. For instance, this software download may be triggered and controlled by the generic control software 110 which is partially installed on the client node 104 (see reference numeral 114) and which is partially installed on the server node 102 (see reference numeral 112). After this download, the server node 102 and/or the client nodes 104 are in a position to control the newly added sample separation device 106′, for instance controlling a sample separation task carried out by said sample separation device 106′ without the need of any previous software update on the server node 102 or the client nodes 104. This increases the flexibility and reduces the effort of operating network 100.

FIG. 2 shows the detailed construction of a liquid sample separation device 106 of the network 100 of FIG. 1, particularly used in high performance liquid chromatography (HPLC).

More specifically, FIG. 2 depicts a general schematic of the sample separation device 106 according to FIG. 1. A fluid drive 20 (such as a piston pump) receives a mobile phase from a solvent supply 25 (at reference sign 58) via degassing unit 27, which degases and thus reduces the amount of dissolved gases in the mobile phase. The fluid drive 20 drives the mobile phase through a separation unit 30 (such as a chromatographic column) comprising a stationary phase. A sampler or injector 40, implementing a fluidic valve 90, can be provided between the fluid drive 20 and the separation unit 30 in order to subject or add (often referred to as sample introduction) a sample fluid (at reference sign 57) into the mobile phase so that a fluidic sample and mobile phase may be provided towards a separation path where actual sample separation occurs. The stationary phase of the separation unit 30 is configured for separating compounds of the sample liquid. A detector 50 is provided for detecting separated compounds of the sample fluid. A fractionating unit 60 (at reference sign 59) can be provided for outputting separated compounds of sample fluid.

While the mobile phase can be comprised of one solvent only, it may also be mixed from plural solvents. Such mixing might be a low pressure mixing and provided upstream of the fluid drive 20, so that the fluid drive 20 already receives and pumps the mixed solvents as the mobile phase. Alternatively, the fluid drive 20 may comprise plural individual pumping units, with plural of the pumping units each receiving and pumping a different solvent or mixture, so that the mixing of the mobile phase (as received by the separation unit 30) occurs at high pressure and downstream of the fluid drive 20 (or as part thereof). The composition of the mobile phase may be kept constant over time, the so called isocratic mode, or varied over time, the so called gradient mode.

A data processing unit or control unit 70, which can be a PC or workstation, may be coupled (as indicated by the dotted arrows) to one or more of the devices in the sample separation device 106 in order to receive information and/or control operation. For example, the control unit 70 may control operation of the fluid drive 20 (for example setting control parameters) and receive therefrom information regarding the actual working conditions (such as output pressure, etc. at an outlet of the pump). Optionally, the control unit 70 may also control operation of the solvent supply 25 (for example setting the solvent/s or solvent mixture to be supplied) and/or the degassing unit 27 (for example setting control parameters and/or transmitting control commands) and may receive therefrom information regarding the actual working conditions (such as solvent composition supplied over time, vacuum level, etc.). The control unit 70 may further control operation of the sampling unit or injector 40 (for example controlling sample injection or synchronization sample injection with operating conditions of the fluid drive 20). The separation unit 30 may also be controlled by the control unit 70 (for example selecting a specific flow path or column, setting operation temperature, etc.), and send—in return—information (for example operating conditions) to the control unit 70. Accordingly, the detector 50 may be controlled by the control unit 70 (for example with respect to spectral or wavelength settings, setting time constants, start/stop data acquisition), and send information (for example about the detected sample compounds) to the control unit 70. The control unit 70 may also control operation of the fractionating unit 60 (for example in conjunction with data received from the detector 50) and provides data back.

Apart from the detailed construction of the sample separation network 106, FIG. 2 also shows schematically the connection of said sample separation device 106 within the sample separation network 100. Via a communication network 150 (such as the public Internet, an Intranet, or any other kind of wired or wireless communication network), the sample separation device 106 may be communicatively coupled to the server node 102 and/or the client nodes 104 as well as to other sample separation devices 106 of the sample separation network 100. As shown, each of the client nodes 104 may comprise a corresponding processor 122 to carry out the processing tasks required within the operation of the sample separation network 100. Correspondingly, also the server node 102 comprises a corresponding processor 120. A processor 118 may also form part of the control unit 70 controlling the sample separation operation of the sample separation device 106. Such a processor 118 may also be present in each of the other sample separation devices 106 (not shown). As shown as well as in FIG. 2, the processor 118 of the sample separation device 106 may communicate with a database storing the device-specific control software 108, and optionally additional software and/or data.

FIG. 3 shows a hardware and software configuration of a sample separation device 106 communicatively coupled with a server node 102 or a client node 104 according to an exemplary embodiment.

FIG. 3 illustrates a detailed construction of a sample separation device 106 which is composed of multiple hardware components 156, each having assigned a software component in form of firmware 158. As shown in FIG. 3, the sample separation device 106 is composed of multiple modules 154, such as a fluid drive unit 20, a detector 50, etc. Furthermore, solvent bottles 152 are shown which are used for providing the sample separation device 106 with a solvent composition, for instance for creating a mobile phase. As shown as well in FIG. 3, the sample separation device 106 stores device-specific control software 108 (which is not stored on nodes 102, 104) and is communicatively coupled with a node, which can be a server node 102 or a client node 104. For instance, the device-specific control software 108 may be a sample separation related user interface. The node has stored a generic control software 110 (which is not stored on device 106) which is not correlated with a specific sample separation functionality of the sample separation device 106 at all. In contrast to this, the generic control software 110 is a general purpose software capable of fulfilling multiple sample-separation unspecific tasks.

In contrast to this, the generic control software 106 installed on the node 102 or 104 may be a generic driver for which updates are only necessary after a long-term, after which an entire network 100 is updated. Reference sign 160 in FIG. 3 denotes an instrument control framework (ICF) interface for the driver (defining how an access is carried out). Furthermore, an adapter software 162 is provided comprising one or more adapter layers for the communication system.

Descriptively speaking, the architecture according to FIG. 3 moves user interface definitions in form of device-specific control software 108 to the sample separation device 106 rather than to any of the nodes 102, 104. Descriptively speaking, this decouples instrument specifics from general purpose software implementation on the nodes 102, 104.

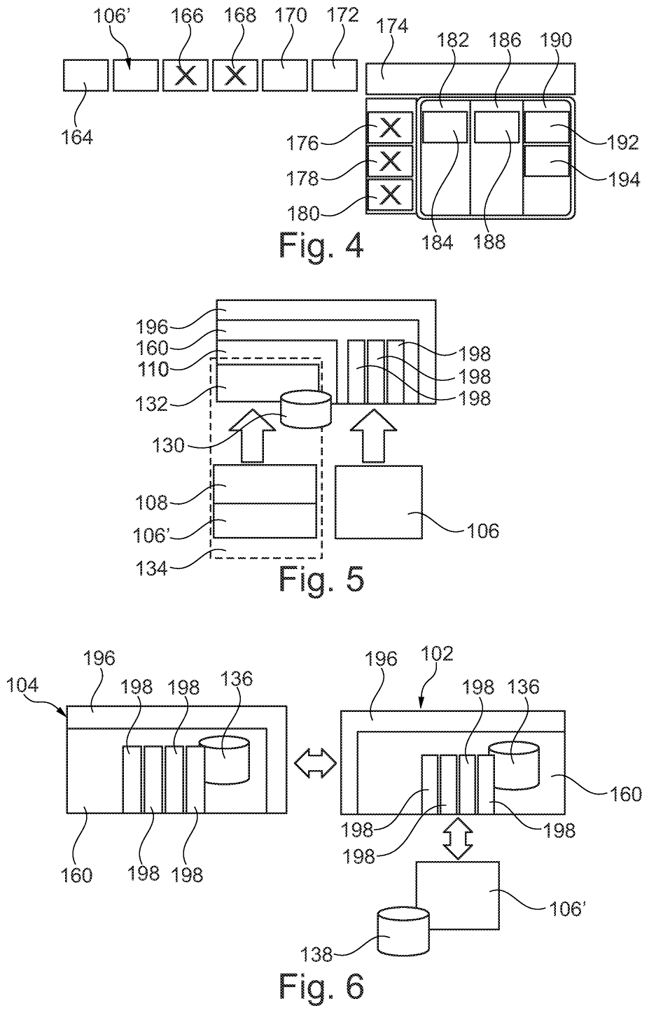

FIG. 4 illustrates a limited software reconfiguration effort when adding a new sample separation device 106′ to an existing sample separation network 100 according to an exemplary embodiment.

FIG. 4 illustrates the scenario that a new sample separation device 106′ is added to an existing sample separation network 100. Thus, FIG. 4 relates to the scenario that a new sample separation device 106′ is added to the already connected sample separation devices 106, i.e. a model which has never been used by the sample separation network 100. According to FIG. 4, such a connected sample separation device 106′ may be integrated into the sample separation network 100. Reference sign 164 indicates a new analytical problem added. As indicated by reference sign 166, the above-described software configuration makes it dispensable to check the compatibility of the newly added sample separation device 106′ with a hardware, firmware or software. As shown by reference sign 168, there is also no need to wait for a third party support when integrating the sample separation device 106′ to the sample separation network 100. As shown by reference sign 170, it may be sufficient to order the instrument and, compare reference sign 172, to make an appointment for the installation. Reference sign 174 indicates that a continuous lab operation is then performed. Only for the newly added sample separation device 106′, some tasks may then be carried out. No validation efforts have to be made for the already installed sample separation devices 106, as well as for the server node 102 and the client nodes 104. What concerns efforts for a software update, neither an update of the server node 102 or the client nodes 104 (see reference sign 176), nor an update of drivers (see reference sign 178) nor an update of the firmware (see reference sign 180) is necessary. In terms of verification 182, an IQ/QQ task may be carried out. In terms of training 186, the lab personnel may be trained. What concerns validation 190, multiple runs may be carried out with existing samples and methods (see reference sign 192), and statistics may be made (see reference sign 194). All these tasks are carried out only for the newly added sample separation device 106′, not for the rest of the sample separation network 100.

FIG. 5 shows a configuration of a sample separation network 100 according to an exemplary embodiment enabling the connection of a new sample separation device 106′ to the network 100 without changes in an existing validated software installation.

FIG. 5 thus illustrates that the sample separation network 100 supports the addition of a new sample separation device 106′ without changes in the existing, validated software installation of the sample separation network 100. In particular, it may be possible to implement a generic control software 110 that runs within the server node 102 and/or client nodes 104. Furthermore, it may be possible to upload the device-specific control software (which may also be denoted as instrument specific content) 108 from the added sample separation device 106′. Furthermore, the system allows an offline method editing using a cash 130. As indicated by reference sign 134, validation needs only be performed for the newly added sample separation device 106′, but no revalidation of the existing installation of the server node 102 and the client nodes 104 is necessary.

FIG. 5 shows an old instrument, i.e. an already connected sample separation device 106, as well as a newly added instrument, i.e. presently connected sample separation device 106′. Reference sign 132 indicates the uploaded content. Reference sign 196 indicates the server node or the client node. Reference sign 198 indicates driver software.

FIG. 6 shows a configuration of a server node 102 and a client node 104 enabling a simplified connection of a new sample separation device 106′ to a sample separation network 100 according to an exemplary embodiment.

FIG. 6 shows schematically modifications made to a sample separation network 100 upon connecting a new sample separation device 106 (having an instrument configuration 138 stored thereon). In terms of a client node 104, an uploaded instrument configuration 136 is shown as well as driver software 198. What concerns the server node 102, also an uploaded instrument configuration 136 and driver software 198 is shown.

Thus, driver software 198 may be installed on the acquisition controller (i.e. the server node 102) and the client nodes 104. The configuration holds the instrument specifics, i.e. the specific characteristics of the sample separation device 106′, and defines the driver behaviour for this specific instrument. The configuration may be initially uploaded from the instrument and may be stored in the software as instrument configuration 136. The configuration 136 may be provided whenever a user interface is used, for example offline editing.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A sample separation network, comprising:
a server node;
a plurality of client nodes communicatively coupled with the server node;
wherein each of the sample separation devices comprises device-specific control software configured for controlling specifically the respectively assigned sample separation device;
wherein at least one of the server node and the client nodes comprises generic control software configured for generically controlling sample separation devices in a non-device-specific way; and
wherein at least one of the server node and the client nodes and the sample separation devices is configured for loading device-specific control software from a sample separation device to at least one of the server node and the client nodes upon connection of said sample separation device to the sample separation network.

2. The sample separation network according to claim 1, comprising one of the following:
wherein the generic control software is incapable of controlling the sample separation devices in a device-specific manner;
wherein the generic control software is incapable of providing sample separation specific control commands to the sample separation devices.

3. The sample separation network according to claim 1, wherein the generic control software is incapable of controlling a respective one of the sample separation devices, without the assigned device-specific control software.

4. The sample separation network according to claim 1, wherein the device-specific control software is configured for controlling any of the sample separation devices.

5. The sample separation network according to claim 1, wherein a part of the generic control software is installed on the server node and another part of the generic control software is installed on at least one of the client nodes.

6. The sample separation network according to claim 1, wherein the client nodes are communicatively coupled with the sample separation devices (106) only indirectly via the server node.

7. The sample separation network according to claim 1, wherein the server node is configured for controlling a plurality of sample separation devices.

8. The sample separation network according to claim 1, wherein the generic control software comprises a driver interface for driving the sample separation devices.

9. The sample separation network according to claim 1, wherein said at least one of the server node and the client nodes and the newly connected sample separation device is configured for loading said device-specific control software from said sample separation device triggered merely by the event of connecting said sample separation device to the sample separation network without additional user intervention.

10. The sample separation network according to claim 1, wherein the generic control software comprises or consists of a browser.

11. The sample separation network according to claim 1, wherein the device-specific control software is configured for controlling the respectively assigned sample separation device to carry out a sample separation process of separating a fluidic sample.

12. The sample separation network according to claim 1, wherein at least one of the sample separation devices comprises:
a fluid drive for driving mobile phase and a fluidic sample to be separated when injected in the mobile phase; and
a sample separation unit for separating the fluidic sample injected in the mobile phase.

13. The sample separation network according to claim 1, wherein at least one of the sample separation devices comprises at least one feature of the group consisting of:
the sample separation device is configured as a chromatography sample separation device, in particular a liquid chromatography sample separation device or a supercritical fluid chromatography sample separation device;
the sample separation device comprises a detector configured to detect separated fractions of a fluidic sample;
the sample separation device comprises a fractioner unit configured to collect separated fractions of a fluidic sample;
the sample separation device comprises an injector configured to inject a fluidic sample in a mobile phase.

14. A method of operating a sample separation network, the method comprisings:
communicatively coupling a plurality of client nodes with a server node;
communicatively coupling a plurality of sample separation devices with the server node;
providing each of the sample separation devices with device-specific control software configured for controlling specifically the respectively assigned sample separation device;
providing at least one of the server node and the client nodes with generic control software configured for generically controlling sample separation devices in a non-device-specific way; and
loading device-specific control software to said at least one of the server node and the client nodes from a sample separation device upon connection of said sample separation device to the sample separation network.

15. The method according to claim 14, wherein the method comprises loading said device-specific control software and subsequently operating the connected sample separation device in terms of separating a fluidic sample without previously updating the server node and/or the plurality of client nodes in accordance with the device-specific control software of the sample separation device connected to the sample separation network.

16. The method according to claim 14, wherein the method comprises controlling the sample separation device after its connection to the sample separation network by at least one of the server node and the client nodes without previously carrying out a software update neither on the server node nor on the client nodes after said connecting.

17. The method according to claim 14, wherein the method comprises controlling a respectively assigned sample separation device to carry out a sample separation process of separating a fluidic sample using said device-specific control software.

18. The method according to claim 14, wherein neither the server node nor the client nodes stores device-specific control software for specifically controlling a specific sample separation device before connecting said sample separation device to the network.

19. A non-transitory computer-readable medium with instructions stored thereon, that when executed by a processor, control the steps of the method of claim 14.

20. A program element of operating a sample separation network, which program element, when being executed by one or a plurality of processors is adapted to carry out or control a method according to any of claims 14 to 18.
